(19) United States
(12) Patent Application Publication
(10) Pub. No.: US 2001/0030206 A1
(43) Pub. Date: Oct. 18, 2001

(54) One-piece push-pull cap with non-spurting clean top

(76) Inventor: Gene Stull, Far Hills, NJ (US)

Correspondence Address: GOODWIN PROCTER, LLP, 7 Becker Farm Road, Roseland, NJ, 07068, US

(21) Appl. No.: 09/749,114

(22) Filed: Dec. 26, 2000

Related U.S. Application Data
(60) Provisional application No. 60/171,942, filed on Dec. 23, 1999.

(51) Int. Cl. B67D 5/06

(52) U.S. Cl. 222/522

(57) ABSTRACT

A one-piece push-pull non-spurting clean cap having a front and a back including a diagonal support, an inner diameter container seal attached to the diagonal support at the back, a conical depression attached to the inner diameter container seal, a translatable gate valve attached to the diagonal support at the front of the cap, a vertical member attached to the diagonal support adjacent to the translatable gate valve and closer to the back than the translatable gate valve, a top attached to the conical depression at said back, and attached to the diagonal support at said front, and an outlet port disposed on the top of the cap for dispensing product therefrom.

### RELATED APPLICATIONS

This application claims the priority of Provisional No. 60/171,942, filed on Dec. 23, 1999.

### BACKGROUND OF THE INVENTION

The present invention is directed to a one-piece, push-pull cap with a non-spurting clean top having application for various types of containers. In addition, the invention relates to a cap that features the capability of liquid flow adjustably due to the telescopic design by pulling up the cap.

The term “container” as used herein and in the claims, is to be interpreted as being inclusive of glass or plastic bottles, metallic cans, jars, cups, bottles and the like.

Two-piece dispensing closures comprising a shell having an upstanding substantially cylindrical chimney and tip mounted on the chimney shiftable with respect to the open and closed positions have been used in the past. For example, a dispensing closure with a tip having a push-pull relationship with the chimney has been used in connection with dispensing many fluids. The captive nature of the tip with respect to shell eliminates the requirement of a separate cap means. However, the two-piece construction requires unnecessary molding of parts.

In addition, “twist open” dispensing closures having a tip member threaded onto the chimney of the shell have been used in the past. Such twist-open dispensing closures, however, due to the necessity for full threads thereon, generally are expensive to mold in that the dye member forming the threads must be unscrewed from the molded part. Such closures are also less convenient for the user than push-pull type closures because of the large amount of twist necessary to unscrew the tip member sufficiently to open the closure.

Two-piece push-pull closures have dispensed numerous fluids such as, for example, water, dishwashing liquid and juice. In addition, two-piece non-spurting push-pull dispensing closures have been used such as those described in U.S. Pat. Nos. 4,065,037 and 3,981,421. These patents teach two-piece non-spurting push-pull closures with non-spurting features. The '421 patent discloses a dispensing closure comprising a shell having a substantially cylindrical chimney and a tip mounted on the chimney and shiftable between a retracted closed position and an extended open position. The chimney is provided with angled ribs on its exterior surface and the tip is provided with cooperating lugs on its interior to provide a limited degree of relative rotation between the tip and the chimney during the shifting of the tip between its open and closed positions. However, the '421 patent requires a two-piece apparatus to achieve a non-spurting product flow.

The '037 patent discloses a two-piece twist-open, anti-spurt, dispensing closure for dispensing viscous or thixotropic material requiring mixing or shaking immediately prior to dispensing. The dispensing closure of the '037 patent comprises a shell with a chimney and a tip so constructed so that a limited twisting of the tip with respect to the chimney is required to shift the tip between its open and closed positions. The tip may be snap fit assembled to the shell and is captively held thereon. In addition, the tip is telescopically and rotatively mounted on the chimney. The top is shiftable between an extended open position and a retracted closed position.

However, both of the above-mentioned prior art push-pull dispenser closures require a two-piece apparatus wherein the shell portion is attached to the neck of a bottle, container or the like. The tip portion is then attached to the shell portion in order to dispense liquid or to close the container. This two-piece apparatus requires additional molding of the shell piece thereby increasing cost.

The present invention solves this and other problems by providing a one-piece dispensing closure while providing selective flow therefrom. In addition, the present invention provides a rotatble means whereby flow can be further selectively dispensed from the closure due to an opening at the side of the closure. Further, the present invention is relatively inexpensive to manufacture, reliable, and easy to operate.

What is desired therefore is a one-piece push-pull cap for imparting a non-spurting product flow.

It is also desired to provide a device to horizontal support and vertical member for restricting product flow.

It is also desired to provide a device to selectively increase product flow through the use of notched container neck to restrict movement of the cap.

It is also desired to provide an axially rotatable cap for restricting product flow from a container.

### SUMMARY OF THE INVENTION

The present invention overcomes the drawbacks of the prior art by providing in a first aspect a one-piece push-pull non-spurting clean cap having a front and a back comprising, a diagonal support, an inner diameter container seal attached to said diagonal support at said back, a conical depression attached to said inner diameter container seal, a translatable gate valve attached to said diagonal support at said front, a vertical member attached to said diagonal support adjacent to said translatable gate valve and closer to said back than said translatable gate valve, a top attached to said conical depression at said back, and attached to said diagonal support at said front, and an outlet port disposed on said top for dispensing product therefrom.

In another aspect of the present invention, the above is further provided to include a side wall attached to said top, a shoulder attached to said side wall, a skirt attached to said side wall, and a lip attached to said skirt.

In a further aspect of the present invention, it is further provided to include an axially rotatable cap for sealably disengaging an outlet port from a container neck.

In still a another aspect of the present invention, it is further provided a device to selectively increase product flow through the use of notched container neck to restrict movement of the cap.

### BRIEF DESCRIPTION OF THE DRAWINGS

These and other objects and advantages of the invention will become more apparent from the following detailed description of a preferred embodiment of the invention when taken into conjunction with the drawings wherein:

FIG. 1 is an elevation view in section of the improved dispensing closure constructed in accordance with the principles of the present invention.

FIG. 2 is a perspective view of FIG. 1.

FIGS. 3a and 3b are elevation views in section of an alternate embodiment of the improved dispensing closure in a closed and open position.

FIGS. 4a-4d are elevation views in section of an alternate embodiment of the improved dispensing closure having closed, 1/4 open, 1/2 open and fully open positions.

FIG. 5a is a perspective view of an alternate embodiment having a side hole for dispensing liquid.

FIG. 5b is an elevation view in section of FIG. 5b.

### DETAILED DESCRIPTION OF THE PREFFERED EMBODIMENT

Reference made to fluids, liquids and products should be understood to one of ordinary skill in the art to include other materials such as fine granular materials or the like.

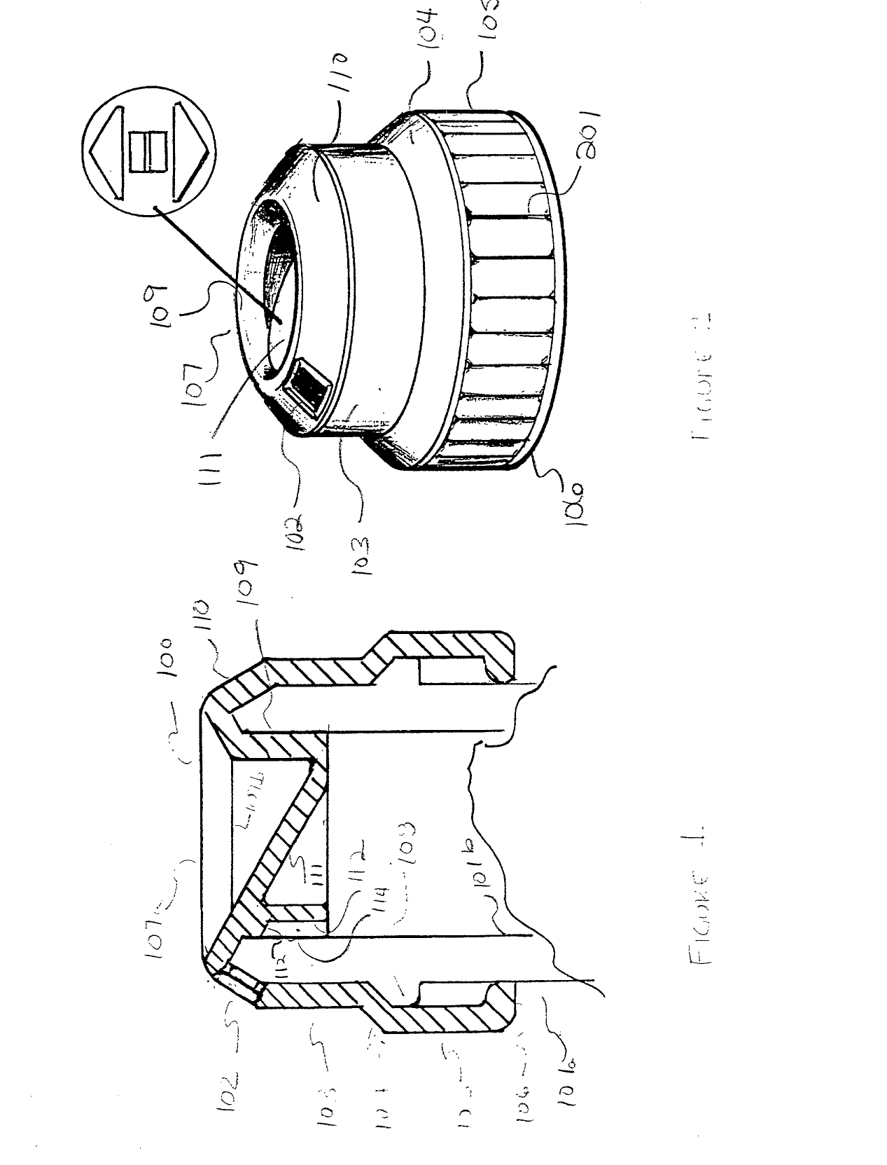

In addition, FIGS. 2-5 that depict the same features as shown in FIG. 1 will not be described in detail, only the differences therefrom being hereinafter described and detailed and the modified component parts and elements will be herein after be referred to by the same character as utilized in FIG. 1.

Referring to FIG. 1, a closure for selectivly dispensing products from a container is shown. The container includes a neck at the top portion of the container, which forms a circumferential opening at the top so that fluids may exit therefrom. The neck has a bottom portion wherein the neck meets with a shoulder portion of the container. In addition, the neck has a peripheral wall having an interior diameter surface and an exterior diameter surface. The neck also has a top portion wherein the interior and exterior surfaces are joined, and wherein each surface angles toward the other by a respective inward and outward bevel of a particular angle, so as to meet at a point. Such a connection may also be rounded at the top. As can been seen in FIG. 1, such angling does not have to be symmetrical. On the exterior surface, the neck also has an annular rib about its circumference located approximately midway between the bottom and the top of the neck. The annular rib has a downwardly depending upper portion and a horizontally extending lower portion. The rib serves to prevent a cap from separating from the neck portion of the container. The cap can slide over the downwardly depending upper portion of the rib on the neck so that when in the closed position, no product may flow out of the container. With the exception of the annular rib, the exterior surface of the neck is smooth and continuous.

In one embodiment, as seen in FIG. 1, the cap includes a lip, a skirt, a shoulder, a side wall, a top wall, a wedge, an outlet port, a translatable gate valve, and a vertical member. The cap also has a front and a back. The outlet port is located at the front of the cap. The wedge expands downwardly from the uppermost portion of the cap from the front to the back of the cap. The translatable gate valve is also located at the front of the cap and is in sealable contact with the neck of the container so as to prevent the flow of product when the cap is in the “closed” position.

The top wall is annularly angled in an inverse conical shape and connected to the side wall. As shown in FIG. 1, the uppermost part of the side wall connects to the angled portion which in turn connects to the diagonal support, thus creating wedge on the exterior of the cap. The lowermost portion of the side wall is connected to the shoulder which is angled in a manner to follow the downward angle of the neck rib. The shoulder is connected to the skirt, which is in turn connected to an annular lip. In order for the cap to remain captive on the container the annular lip extends horizontally around the lower most portion of the cap. The cap is made of deformable material, which allows for sufficient annular displacement so as to expand around the circumference of the neck rib and having memory to return to its original shape. The cap, when placed over the neck will bend so that the annular lip will fit over the neck. It may not be easily removed, as the lower portion of the annular neck rib is horizontally oriented.

As stated above, the cap includes an annular side wall, in which the uppermost portion is connected to the top wall. The top wall follows the angle of the outside side wall bevel of the neck. The top wall extends upwardly toward a horizontal plane bounding the uppermost portion of the cap. Attached to the top wall is a conical depression extending downwardly along the inside wall bevel of the neck. The conical depression, once extended beyond the edge of the inside bevel to the neck, extends vertically downward.

The side wall meets with the top wall which angles inwardly at the same angle as the outer side wall of the neck to follow the outer bevel so as to meet with the upper horizontal boundary of the cap.

In the front of the cap there is an outlet port, located on the top wall, that, when in the “open” position, allows product to flow therefrom.

The interior of the side wall of the cap defines a cavity generally encompassing the exterior side wall of the neck. The cap side wall extends along the same axis as the neck of the container. In addition, when in the “closed” position, the cap side wall follows the downward angle of the annular rib on the container neck and then continues vertically downward to form a skirt and ending at the annular lip.

The top wall of the cap is bounded by an uppermost plane extending horizontally across the upper most portion of the neck and runs across the top wall of the cap. The horizontal plane has an upper and a lower portion defined by a wedge. At the top wall of the cap starting at the horizontal plane, the diagonal support extends downwardly from the top wall (and outlet port) so as to follow the angle of the inside side wall bevel of the neck. On the front side, the top wall of the cap continues to follow the angle of the inside neck bevel in a downward diagonal direction until the diagonal support meets the opposing inside side wall of the neck. A translatable gate valve is attached to the upper portion of the diagonal support. As shown in FIG. 1, the gate valve is a small lipped extension of the cap and covers the inside wall of the neck so as to extend vertically downward beyond the inside beveled edge in order to create a seal that prevents products from flowing out of the container. The lower portion of the diagonal support then extends parallel to the upper portion of the diagonal support so as to also extend diagonally downward following the angle of the container's inner side wall beveled edge.

Depending from the diagonal support is a vertical member. The vertical member extends downward to the point in which the diagonal support meets the inner diameter container seal. The inner diameter container seal extends vertically upward until it meets with the conical depression on the back of the cap. Product can then only flow into the space between the vertical member and the inside side wall of the container neck. The inner diameter container seal is continually in sealing engagement with the inner surface of the container neck, thereby preventing product from passing into the lower portions of the cap construction and contaminating the neck rib or inside surface of the cap side wall. When the cap is vertically raised (when the container is oriented upright) product can flow though the space and out of the outlet port in a controlled manner. In an alternate embodiment, the space defined by the container neck and the vertical member may be increased for additional flow or for more viscous products. In addition, that same space may be decreased in size to reduce flow or for less viscous products. The size of the translatable gate valve should be adjusted accordingly.

At the back of the cap, connected to the top wall, the conical depression extends only so as to cover the beveled inside side wall of the neck. After extending beyond the inside bevel of the neck, the conical depression meets the inner diameter container seal, which extends vertically downward so as to meet with the diagonal support.

FIG. 2 shows the dispensing closure of FIG. 1 in perspective view. As can be seen, a skirt extends about the circumference of the cap. The skirt has on its exterior a plurality of transverse splines so as to facilitate gripping of the cap. The skirt is then attached to the shoulder, which is angled along with the downward angle of the neck rib. The shoulder is then attached to the side wall, which extends vertically upward until is meets the top wall of the cap. The top wall of the cap has an inverse conical shape so that the diameter decreases as is moves toward the horizontal plane bounding the uppermost portion of the cap.

The outlet port is oriented on the top wall of the cap so that product may flow therefrom. At the center of the top wall of the cap, there is a cavity defining a wedge formed by the diagonal support.

The center portion of the top plane of the cap extends diagonally downward inside the neck from the exterior side wall of the container toward the location of the product in the container until it comes in contact with an opposing interior side wall of the container. At the opposing interior side wall, the cap extends upward to the horizontal plane extending across the top of the neck. This portion is defined as the inner diameter container seal. The translatable gate valve extends in the same diagonal angle as the diagonal support to prevent product from escaping from the container when the cap is in its downward most position.

As can be seen in FIGS. 1 and 2, when the cap is moved on its vertical axis, the translatable gate valve is raised above the point where the inner and outer bevel meet at the top of container neck so as to allow product to flow from the container through the space defined between the inner neck surface and the cap vertical member. Product will then flow from the space through the outlet port in such a manner that it will not spurt due to the restricted flow. The size of the space is restricted in that the cap is captively mounted on the container neck by the cap lip and the neck rib. Increasing or decreasing the side of the outlet port may alter the amount of product that can flow from the container. Alternatively, placing the neck rib higher or lower on the container neck can also alter the amount of product flow from the container. For example, if the neck rib is located close to the container shoulder, the push-pull cap can only be raised a small amount so that only a small opening will be created between the point of the container neck and the translatable gate valve.

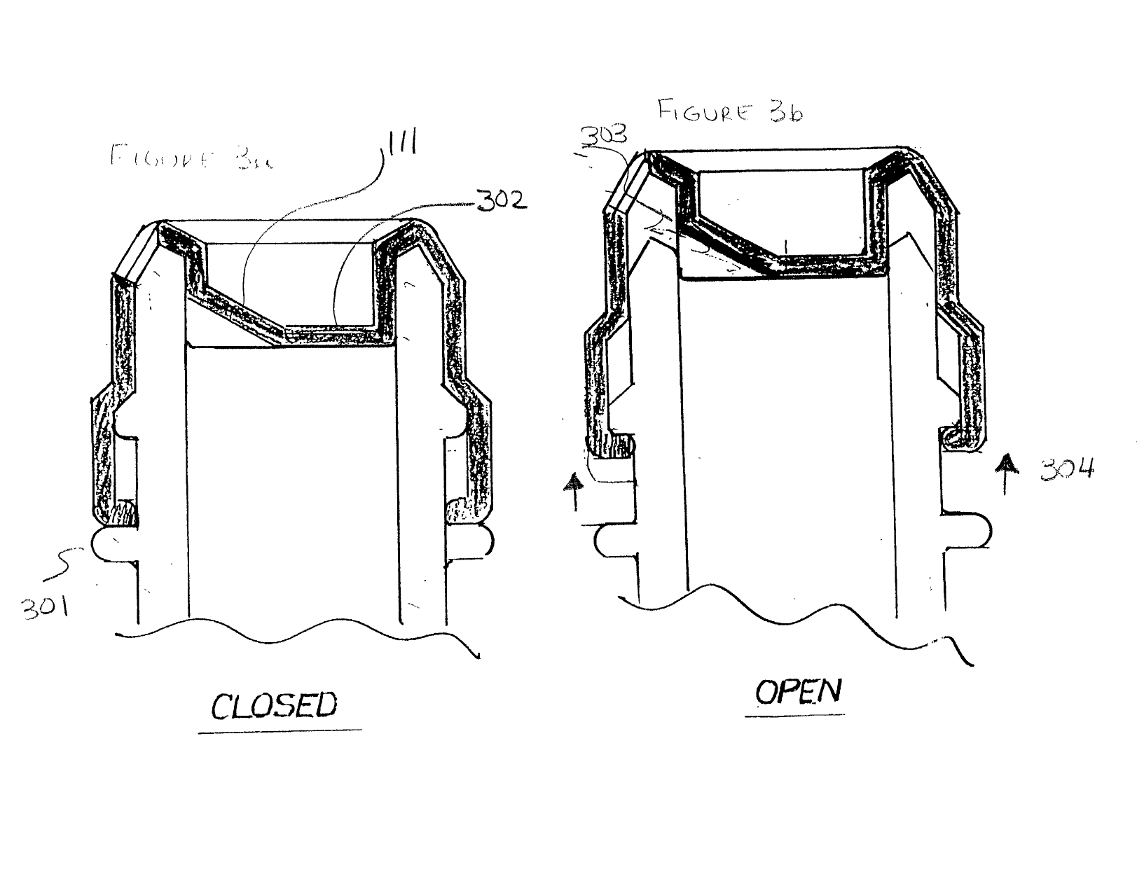

FIGS. 3a and 3b show an alternate embodiment of the improved push-pull non-spurting clean cap, which incorporate much of the features described above in FIGS. 1 and 2. FIG. 3a shows this embodiment in a closed position, while FIG. 3b shows this embodiment in an open position. Here, a second neck rib located closer to the container shoulder is shown. This second neck rib serves to restrict the motion of the cap downwardly and the first rib as described in FIG. 1 serves to restrict the motion of the cap upwardly so as to limit the flow of product through the outlet port. The second rib extends from the container neck horizontally at both the upper and lower portions. The upper portion of the rib does not have a downward angle like the upper portion of the first rib so as to prevent the cap lip from sliding below the lip.

In addition, in this embodiment, no vertical member is employed to restrict the flow of product through the outlet port. This restricted flow is instead achieved by restricting the vertical motion of the cap as described above.

Further, FIGS. 3a and 3b show a truncated diagonal support whereby the inner diameter container seal is connected to a horizontal member that is in turn attached to the horizontal support. This truncated diagonal support further serves to restrict flow of product through the outlet port. This restricted flow prevents the product from spurting out of the outlet port.

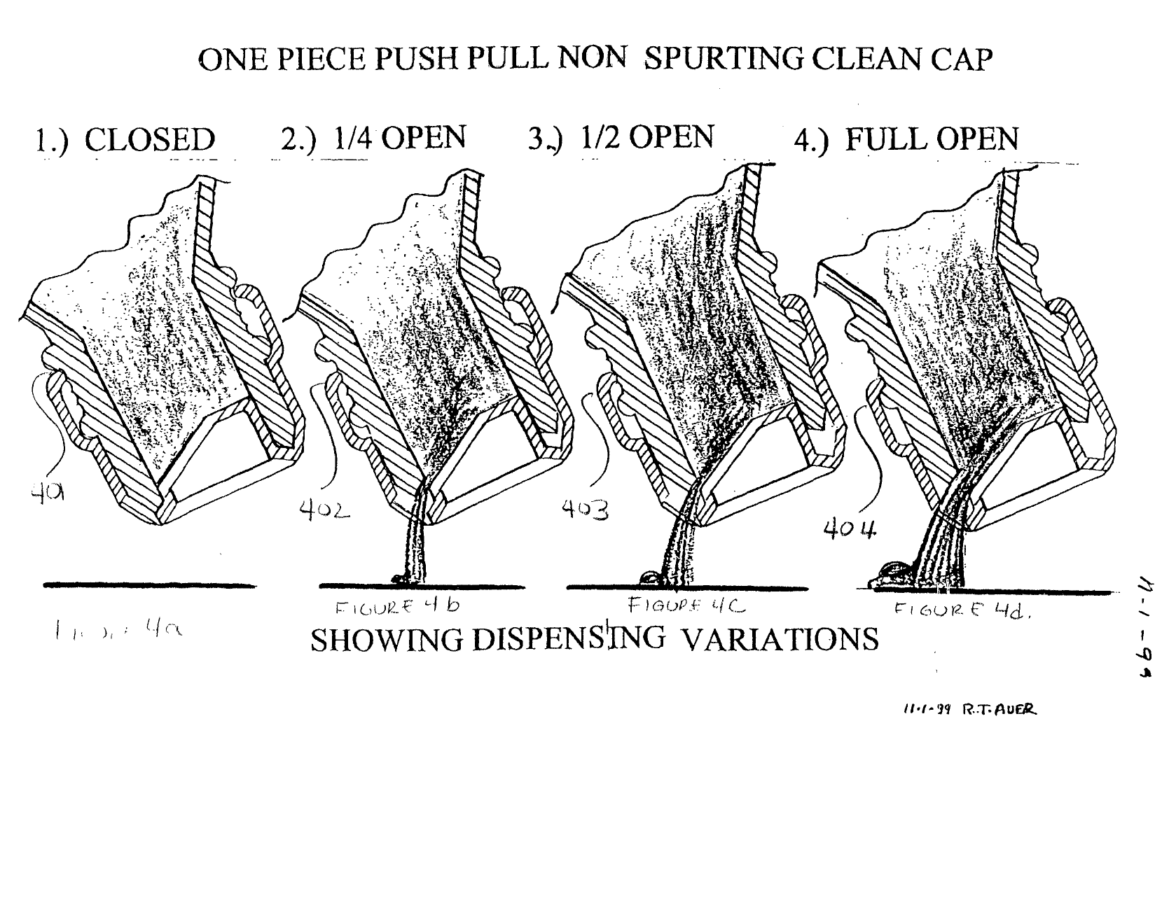

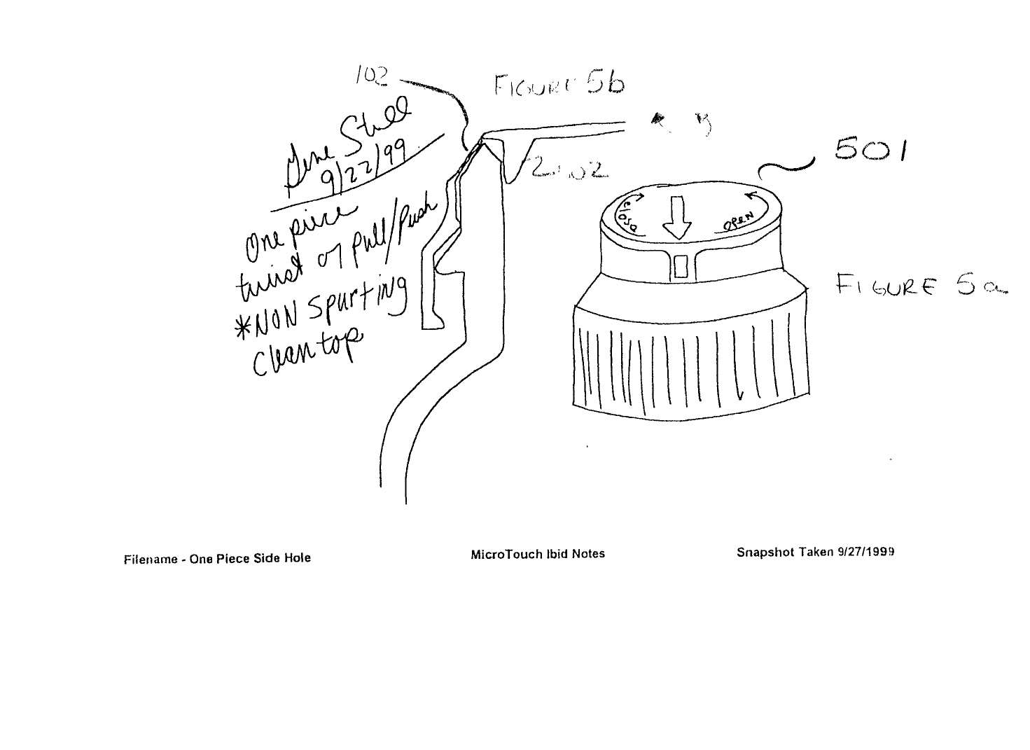

FIGS. 4a-4d show an additional alternate embodiment of the improved cap, which incorporate much of the features described above in FIGS. 1-3. As shown in FIGS. 3a and 3b, FIGS. 4a-4d employ the use of an upper and a lower neck rib. In addition to the embodiment shown in FIGS. 3a and 3b, FIGS. 4a-4d show sequentially spaced notches to incrementally adjust product flow in discrete amounts. FIG. 4a depicts this embodiment in a closed position whereby no flow may be imparted through the outlet port. The cap lip is lodged in the first notch thereby providing no gap between the horizontal support and the container neck. FIG. 4b depicts the cap lip lodged in the second notch whereby a small gap between the horizontal support and the container neck is created, thus allowing for a small amount of product flow through the outlet port because the gap is 1/4 open. FIG. 4c depicts the cap lip lodged in the third notch whereby a larger gap between the horizontal support and the container neck is created so that the product flow is imparted at 1/2 open. FIG. 4d depicts the cap lip lodged in the fourth position whereby a complete opening between the horizontal support and the container neck is provided thereby imparting the fully allowed product flow.

It should be understood by one of ordinary skill in the art that the number and placement of the above-described notches for regulating product flow from a container is merely exemplary of various combinations and modifications thereto. In addition, said notches made be rounded as shown in FIGS. 4a-4d, or triangular or square or the like. Such notches should only be shaped to conform to the shape of the cap lip, which may also be modified as known to one of ordinary skill in the art.

FIGS. 5a and 5b show a further alternate embodiment of the present invention. In FIGS. 5a and 5b the neck rib as shown in FIG. 1 includes helically pitched screw threads for raising and lowering the cap for sealably disengaging an annular neck seal. Thus the cap is axially movable on the container neck in response to its rotation. In the top wall the cap has an outlet port discharging product therefrom. As the cap is raised through axial rotation, the outlet port is disengaged from the outer surface of the container neck. The product flow is restricted by the annular neck seal to prevent spurting.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A one-piece push-pull non-spurting clean cap having a front and a back comprising,
a diagonal support;
an inner diameter container seal attached to said diagonal support at said back;
a conical depression attached to said inner diameter container seal;
a translatable gate valve attached to said diagonal support at said front;
a vertical member attached to said diagonal support adjacent to said translatable gate valve and closer to said back than said translatable gate valve;
a top attached to said conical depression at said back, and attached to said diagonal support at said front; and
an outlet port disposed on said top for dispensing product therefrom.

2. A one-piece push-pull non-spurting clean cap as described in claim 1 further comprising;
a side wall attached to said top;
a shoulder attached to said side wall;
a skirt attached to said side wall; and
a lip attached to said skirt.
